(19) United States
(12) Patent Application Publication
(10) Pub. No.: US 2022/0149420 A1
(43) Pub. Date: May 12, 2022

(54) BATTERY UNIT AND MOTOR VEHICLE PROVIDED WITH AT LEAST ONE SUCH UNIT

(71) Applicant: NOVARES FRANCE, CLAMART (FR)

(72) Inventor: Daniel BRUZZESE, GAP (FR)

(21) Appl. No.: 17/430,604

(22) PCT Filed: Jan. 24, 2020
(86) PCT No.: PCT/FR2020/050115

§ 371 Date: Aug. 12, 2021

(30) Foreign Application Priority Data
Feb. 15, 2019 (FR) 19/01573

(51) Int. Cl. H01M 10/04; H01M 10/6554; H01M 10/6567

(52) U.S. Cl. CPC H01M 10/0413; H01M 2220/20; H01M 10/6567; H01M 10/6554

(57) ABSTRACT

A battery unit, in particular for an electric or hybrid motor vehicle, includes: battery cells, optionally physically grouped into modules of two or more battery cells, a housing that accepts and surrounds the battery cells. The housing has a bottom wall, on which the battery cells rest, a top wall, arranged above the battery cells, and side walls connecting the lower and upper walls. At least one cooling channel passes through each of the lower and upper housing walls, via which a coolant is able to flow, the cooling channel configured to cover the entirety of the lower wall surface, or of the upper wall. The lower and upper walls are connected by cooling plates, each cooling plate arranged between two adjacent battery cells, or modules thereof, or in contact with at least one battery cell, and configured to transmit the heat generated by the battery cells to the coolant.

### TECHNICAL FIELD

The present disclosure concerns the field of autonomous electric energy sources, in particular those on board motor vehicles, and relates to a battery unit and an electric or hybrid motor vehicle equipped with at least one such unit.

### BACKGROUND

Electric or hybrid vehicles are equipped with batteries allowing to store the electrical energy necessary for their operation. The current challenges require optimizing the design of batteries in order to obtain the best performance in terms of lifespan and driving range. Charging time is also an important factor in the daily use of these batteries. For this purpose, batteries with high storage density are increasingly used. They are generally formed of a plurality of battery cells connected in series or in parallel, the battery cells being able to be physically grouped together under the form of blocks or modules.

These high storage density batteries ideally need to operate in temperatures comprised between 20° C. and 40° C. A too high temperature can significantly impact the lifespan of these batteries. It is therefore necessary to efficiently remove the heat generated by the battery cells.

In the context of on-board vehicle applications, there are air-cooled battery solutions, but the heat exchange remains quite limited. The current trend is to use coolant to improve heat exchange and increase cooling efficiency.

### SUMMARY

One of the existing solutions using a coolant is represented in FIGS. 1a and 1b and is based on the principle of a base support S through which circulates a coolant LR and on which rest a plastic casing B housing battery cells C grouped together in the form of blocks of several cells C separated between them by foam separator plates PS, the heat transfer between the battery cells C and the base support S being ensured by means of aluminum conductive plates PC. Each conductive plate PC has in particular an L-shape, one of the branches of the L being disposed between two adjacent blocks of cells, and the other branch of the L being in contact with the base support S. Nonetheless, this known solution has the drawback of exaggeratingly extending the heat transfer circuit, which limits the efficiency of the cooling. Furthermore, the cost of manufacturing and assembling such battery structures is relatively high.

The disclosure therefore aims to propose an alternative solution to this existing solution and which does not have the aforementioned drawbacks.

To this end, the disclosure relates to a battery unit, in particular for an electric or hybrid motor vehicle, comprising:
a plurality of battery cells, optionally physically grouped together in modules of two or more battery cells,
a casing housing and surrounding said plurality of battery cells, said casing comprising a lower wall, on which the battery cells rest, an upper wall, arranged above the battery cells, and lateral walls connecting the lower and upper walls,

characterized in that each of the lower and upper walls of the casing is traversed by at least one cooling channel, along which a coolant can flow, said cooling channel being configured to cover the entire surface of the lower wall, respectively the upper wall, and by the fact that the lower and upper walls of the casing are connected by a plurality of cooling plates, each cooling plate being disposed between two adjacent battery cells, or modules of adjacent battery cells, or being in contact with at least one battery cell, and being configured to transmit the heat generated by the battery cells to the coolant.

The battery unit of the disclosure may also include one or more of the following characteristics:
each cooling plate is formed in a plastic material and includes a plurality of inner channels extending from an upper end opening into the cooling channel of the upper wall to a lower end opening into the cooling channel of the lower wall, thus allowing a circulation of the coolant from the upper wall to the lower wall through said inner channels.
the cooling plates are formed in a material having a high thermal conductivity.
the constituent material of the cooling plates has a thermal conductivity greater than or equal to 20 W·m⁻¹·K⁻¹, and, preferably, greater than or equal to 100
the cooling plates are formed in a thermally conductive plastic material.
the cooling plates are formed in aluminum.
the cooling plates are substantially flat.
the cooling plates are overmolded with the casing.
the cooling plates are U-shaped.
the cooling plates are glued on the casing.
the casing is provided with at least one inlet orifice and at least one outlet orifice, said inlet orifice, respectively outlet orifice, communicating with the cooling channel so as to allow the inlet, respectively the outlet, of the coolant inside, respectively outside, the casing.
the casing is formed by the assembly of several casing panels fixed together by connection means, said casing panels comprising at least two end panels disposed at each of the ends of the casing and a plurality of intermediate panels interposed between said end panels.
the connection means are screws cooperating with corresponding threads formed inside the casing panels.
at least one of the end panels is equipped with an inlet orifice and/or an outlet orifice, said inlet and/or outlet orifice communicating with the cooling channel so as to allow the inlet, respectively the outlet, of the coolant inside, respectively outside, the casing.
each casing panel is secured to a single cooling plate.

The disclosure also concerns a motor vehicle, in particular an electric or hybrid motor vehicle, equipped with at least one battery unit as described above.

### BRIEF DESCRIPTION OF THE DRAWINGS

Other aspects and advantages of the disclosure will become apparent on reading the description which follows, given by way of example and made with reference to the appended drawings, in which:

FIG. 1a is an exploded perspective view of a battery unit according to the prior art;

FIG. 1b is a cross-sectional view of the battery unit of FIG. 1 a;

FIG. 2 is an exploded perspective view of a first configuration of a battery unit according to the disclosure;

FIG. 3 is a front view of a cooling plate used in the battery unit represented in FIG. 2;

FIG. 4 is a partial cross sectional view of the battery unit represented in FIG. 2;

FIG. 5 is an exploded perspective view of a second configuration of a battery unit according to the disclosure;

FIG. 6 is a perspective view of one of the casing panels of the battery unit represented in FIG. 5, on which a cooling plate has been fixed;

FIG. 7a is a sectional view along the sectional plane AA of FIG. 6;

FIG. 7b is a sectional view along the sectional plane BB of FIG. 6;

FIG. 8 is a partial cross sectional view of the battery unit according to FIG. 5, in which the shape of the cooling plates differs from that represented in FIGS. 7a and 7b;

FIG. 9 is a schematic view showing the coolant circuit inside the battery unit according to FIG. 5;

FIG. 10 is a front view of the casing panel represented in FIG. 6;

FIG. 11 is a perspective view of the casing of the battery unit represented in FIG. 2;

FIG. 12 is a diagram representing the temperature variations (expressed in ° C.) of the battery cells as a function of the cooling cycles (expressed in seconds) in a battery unit according to the prior art;

FIG. 13 is a diagram representing the temperature variations (expressed in ° C.) of the battery cells as a function of the cooling cycles (expressed in seconds) in a battery unit according to a first embodiment of the disclosure;

FIG. 14 is a diagram representing the temperature variations (expressed in ° C.) of the battery cells as a function of the cooling cycles (expressed in seconds) in a battery unit according to a second exemplary embodiment of the disclosure; and

FIG. 15 is a diagram representing the temperature variations (expressed in ° C.) of the battery cells as a function of the cooling cycles (expressed in seconds) in a battery unit according to a third exemplary embodiment of the disclosure.

### DETAILED DESCRIPTION OF THE DRAWINGS

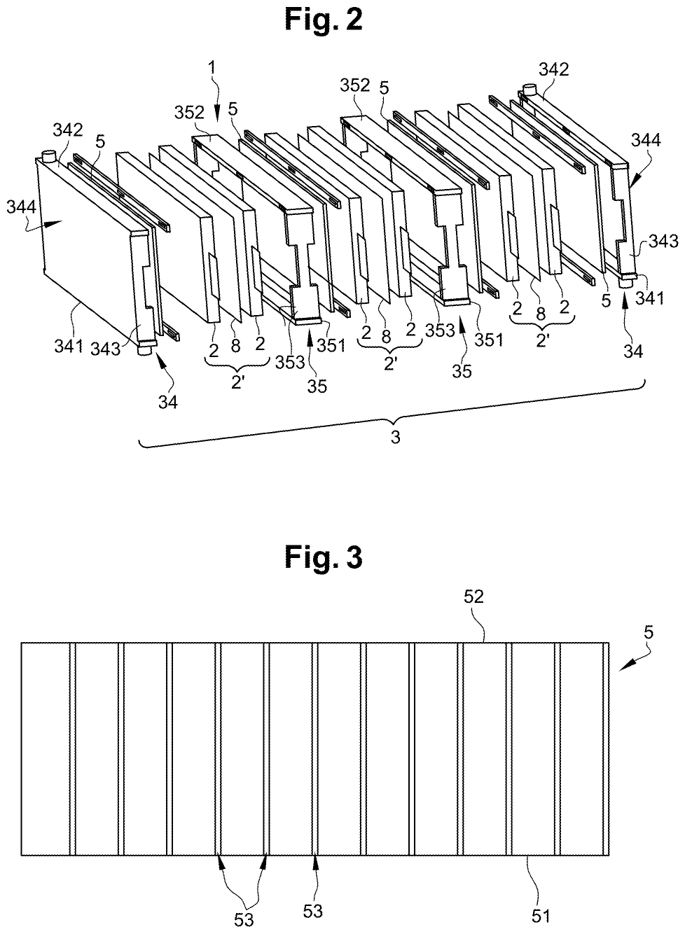

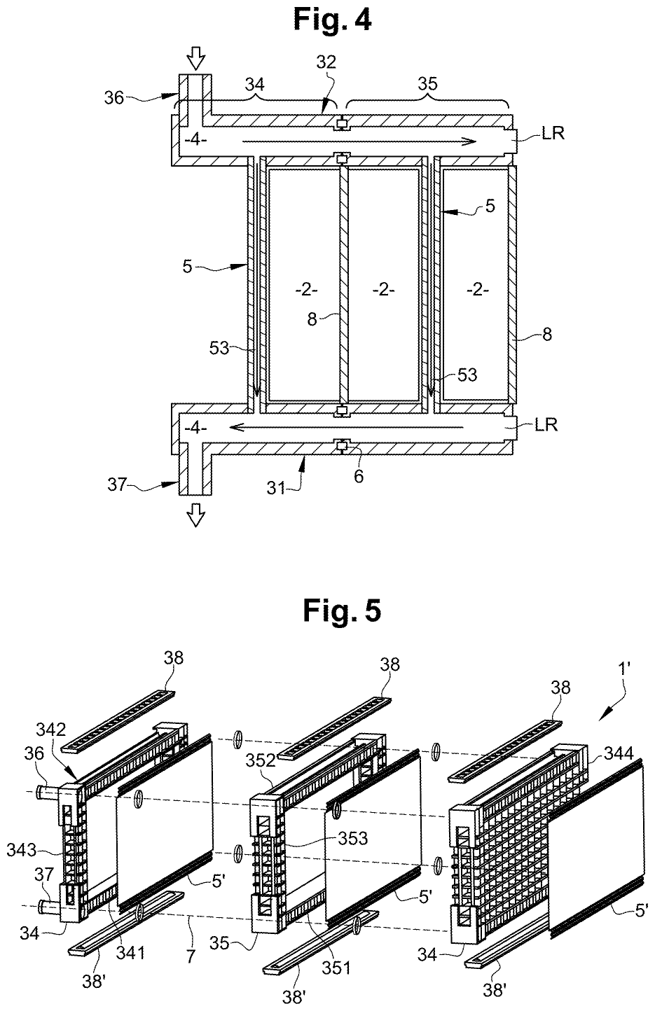

With reference to FIG. 2, there is represented a battery unit 1 according to a first configuration of the disclosure. This battery unit 1 comprises a plurality of battery cells 2, physically grouped into modules 2′ of two battery cells 2 separated by a foam wall 8. In other possible configurations of the disclosure, the number of battery cells 2 in each of the modules 2′ may be greater than two or each module 2′ may include only one single battery cell 2. The battery cells 2 are disposed inside a plastic casing 3 formed by the assembly of two end panels 34 disposed at each of the ends of the casing 3 and a plurality of intermediate panels 35 interposed between said end panels 34. Said panels 34, 35 have substantially the shape of a rectangular parallelepiped and each include a lower wall, respectively 341 and 351, and an upper wall, respectively 342 and 352, said lower and upper walls 341, 342 and 351, 352 being connected by lateral walls 343 and 353 respectively. The end panels 34 further include a transverse wall 344 which is perpendicular to both the lower and upper walls 341, 342 and the lateral walls 343. The casing 3 thus obtained, as represented in FIG. 11, has substantially the shape of a rectangular parallelepiped and includes a lower wall 31 disposed below the battery cells 2 and an upper wall 32 disposed above the battery cells 2, said lower and upper walls 31, 32 being connected by lateral walls 33 disposed on each side of the battery cells 2. As represented in FIG. 4, the panels 34 and 35 being contiguous, the lower 31, upper 32 and lateral 33 walls of the casing 3 are defined respectively by the juxtaposition of lower walls 341, 351, upper walls 342, 352, and lateral walls 343, 353 of the panels 34, 35. The casing 3 is furthermore delimited on each side by the transverse walls 344 of the end panels 34. Furthermore, the lateral walls 353 of the intermediate panels 35 include two central grooves 355 with a U-shaped profile providing a substantially I-shaped to each of the lateral walls 353, each of the central grooves 355 facing either a central groove 355 of an adjacent intermediate panel 35 or a central groove 345 formed in one of the end panels 34. The central grooves 345 and 355 are configured to define a plurality of openings 39 in the lateral walls 33 of the casing 3, said openings 39 allowing the electrical connection terminals of the battery cells 2 to protrude outside the casing 3 and thus to be electrically connected to a motor of an electric vehicle.

As illustrated in FIG. 4, each of the lower and upper walls 31, 32 of the casing 3 is crossed by a cooling channel 4, along which a coolant LR can flow. Each cooling channel 4 extends in particular from an inlet orifice 36, formed at the periphery of one of the end panels 34, to an outlet orifice 37, formed at the periphery of the opposite end panel 34. Each cooling channel 4 will be advantageously configured to cover the entire rectangular surface of the lower 31 or upper wall 32. The inlet 36 and outlet 37 orifices allow the inlet, respectively the outlet, of the coolant LR inside the casing 3 and are in fluid communication with the corresponding cooling channel 4. The coolant LR will thus be able to circulate inside the walls 31, 32 from the inlet orifice 36 to the outlet orifice 37. So as to avoid a leak of the coolant LR at the level of the junction between two adjacent panels of the casing 3, it is advantageously provided seals 6 in mutual engagement with each of the adjacent panels.

Moreover, as represented in FIGS. 2 and 4, the lower and upper walls 31, 32 of the casing 3 are connected by a plurality of cooling plates 5, each cooling plate 5 being disposed between two modules 2′ of adjacent battery cells 2 or being in contact with at least one battery cell 2. These cooling plates 5 are formed of plastic and will advantageously be coextruded with the casing 3. As represented in FIG. 3, these cooling plates 5 are crossed by a plurality of inner channels 53 extending from an upper end 52 opening into the cooling channel 4 of the upper wall 32 to a lower end 51 opening into the cooling channel 4 of the lower wall 31, thus allowing a circulation of the coolant LR from the upper wall 32 to the lower wall 31 through said inner channels 53. Thus, the heat generated by the battery cells 2 will first be transmitted to the cooling plates 5, then directly to the coolant LR circulating inside said cooling plates 5, then inside the lower and upper walls 31, 32 of the casing 3.

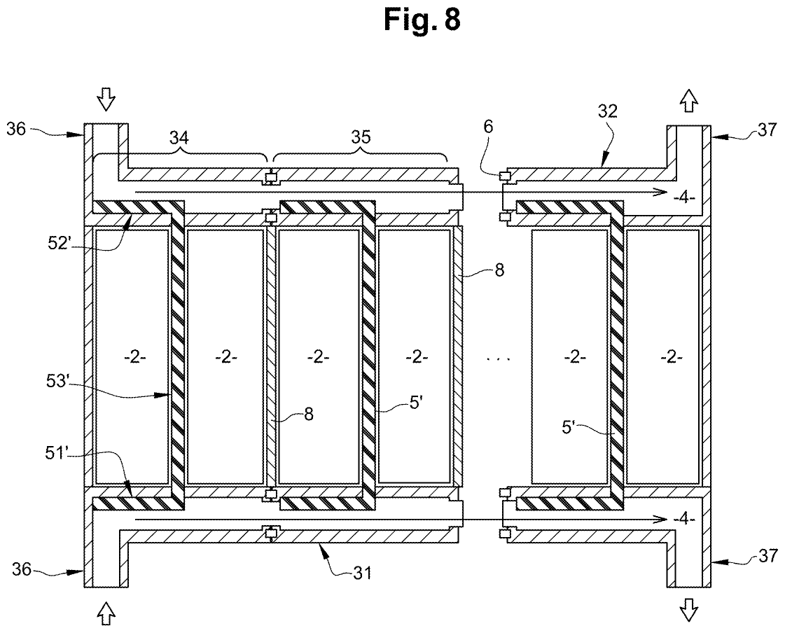

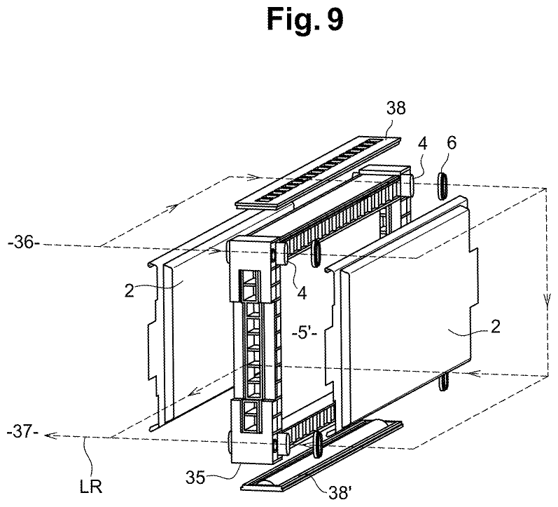

With reference to FIG. 5, there is represented a battery unit 1′ according to a second configuration of the disclosure. This battery unit 1′ comprises a plurality of battery cells 2, which have not been represented for the sake of simplicity in FIG. 5 but which are visible in FIGS. 8 and 9. As in the first configuration, these battery cells can be physically grouped into modules of two or more battery cells 2 separated by a foam wall 8. The battery cells 2 are disposed inside a casing 3 of substantially similar plastic material to that represented in FIG. 11. The casing 3 is in particular formed by the assembly by means of screws 7 of two end panels 34 disposed at each of the ends of the casing 3 and of a plurality of intermediate panels 35 interposed between said end panels 34. Said panels 34, 35 have substantially the shape of a rectangular parallelepiped and each include a lower wall, respectively 341 and 351, and an upper wall, respectively 342 and 352, said lower and upper walls 341, 342 and 351, 352 being connected by lateral walls 343 and 353 respectively. The upper 342, 352 and lower 341, 351 walls of the panels 34, 35 are advantageously covered with protective plates 38 and 38′ respectively. The end panels 34 further include a transverse wall 344 which is perpendicular to both the lower and upper walls 341, 342 and the lateral walls 343. As represented in FIG. 8, the panels 34 and 35 being contiguous, the lower 31, upper 32 and lateral 33 walls of the casing 3 are defined respectively by the juxtaposition of lower walls 341, 351, upper walls 342, 352, and lateral walls 343, 353 of the panels 34, 35. The casing 3 is also delimited on each side by the transverse walls 344 of the end panels 34.

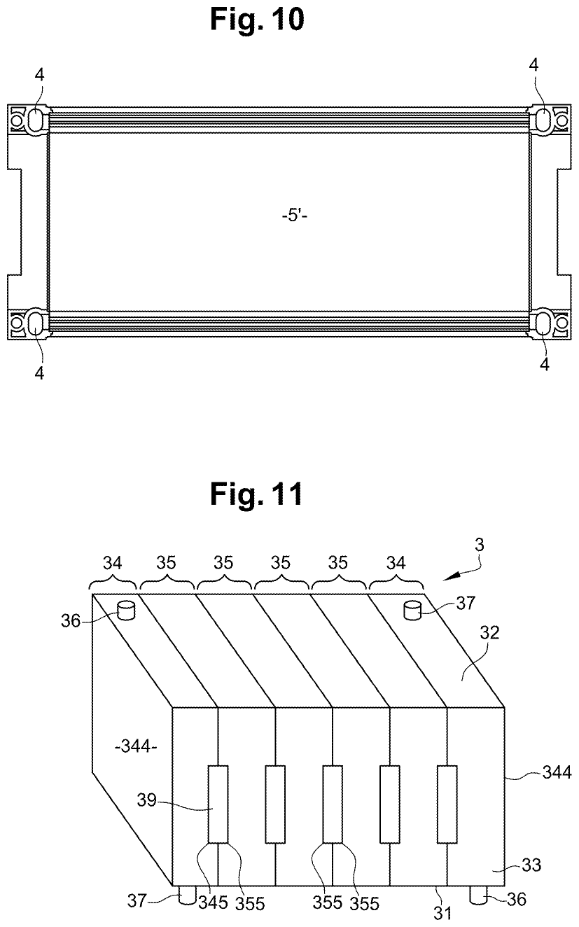

As illustrated in FIGS. 5, 9 and 10, the lower and upper walls 31, 32 of the casing 3 are crossed by a single cooling channel 4, along which a coolant LR can flow. The cooling channel 4 extends in particular from an inlet orifice 36, formed at the periphery of one of the end panels 34 and in its upper part, to an outlet orifice 37, formed at the periphery of this same end panel 34 and in its lower part. The cooling channel 4 is in particular of tubular shape and is configured to first cover the entire rectangular periphery of the upper wall 32, before descending vertically along one of the end panels 34, then to cover the entire rectangular periphery of the lower wall 31. The inlet 36 and outlet 37 orifices allow the inlet, respectively the outlet, of the coolant LR inside the casing 3 and are in fluid communication with said cooling channel 4. The coolant LR will thus be able to circulate inside the walls 31, 32 from the inlet orifice 36 to the outlet orifice 37. In the configuration represented in FIG. 8, each of the lower and upper walls 31, 32 of the casing 3 is crossed by a cooling channel 4. Each cooling channel 4 extends from an inlet orifice 36, formed at the periphery of one of the ends panels 34, to an outlet orifice 37, formed at the periphery of the opposite end panel 34. Each cooling channel 4 is in particular of tubular shape and is configured to cover the entire rectangular periphery of the lower 31 or upper 32 wall. In order to prevent a leak of the coolant LR at the junction between two adjacent panels of the casing 3, it is advantageously provided to have tubular seals 6 around the cooling channel 4, at the junction between two adjacent panels.

Moreover, as represented in FIGS. 5 to 8, the lower and upper walls 31, 32 of the casing 3 are connected by a plurality of cooling plates 5′, each cooling plate 5′ being secured to one of the panels 34, 35 of the casing 3 and being disposed so to be in contact with at least one battery cell 2. These cooling plates 5′ are formed from a material having high thermal conductivity. This material will advantageously have a thermal conductivity greater than or equal to 20 W·m⁻¹·K⁻¹. The cooling plates 5′ may for example be formed of aluminum, or of a thermally conductive plastic material. Nonetheless, it will also be conceivable to use cooling plates 5′ with thermal conductivity of less than 20 W·m⁻¹·K⁻¹. The thermal conductivity of the cooling plates 5′ will vary depending on their thickness.

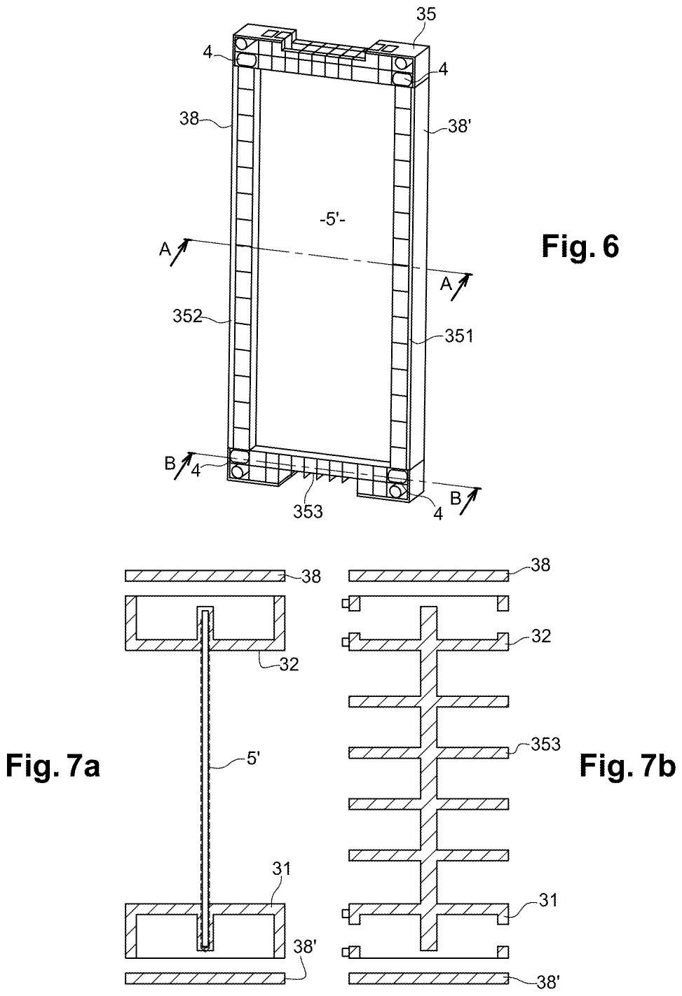

In the configuration represented in FIGS. 6, 7a and 7b, the cooling plates 5′ are substantially flat and are overmolded with the panels 34, 35 of the casing 3 at their ends. Thus, the heat generated by the battery cells 2 will first be transmitted to the cooling plates 5′, then indirectly to the coolant LR by the portions of the casing 3 which surround the ends of the cooling plates 5′.

In the configuration represented in FIG. 8, each of the cooling plates 5′ is U-shaped and comprises a base 53′ connecting an upper branch 52′ to a lower branch 51′. The base 53′ is in contact with at least one battery cell 2 and each of the branches 51′, 52′ is positioned respectively in the cooling channel 4 of the lower 31, respectively upper 32 wall, of the casing 3. In this configuration, the cooling plates 5′ will advantageously be glued to the panels 34, 35 of the casing 3 at their branches 51′, 52′. Thus, the heat generated by the battery cells 2 will first be transmitted to the cooling plates 5′ at their base 53′, then directly to the coolant LR at the level of their branches 51′ and 52′.

In order to show the advantages of the battery unit of the disclosure over a battery unit according to the prior art, the following comparative examples are given.

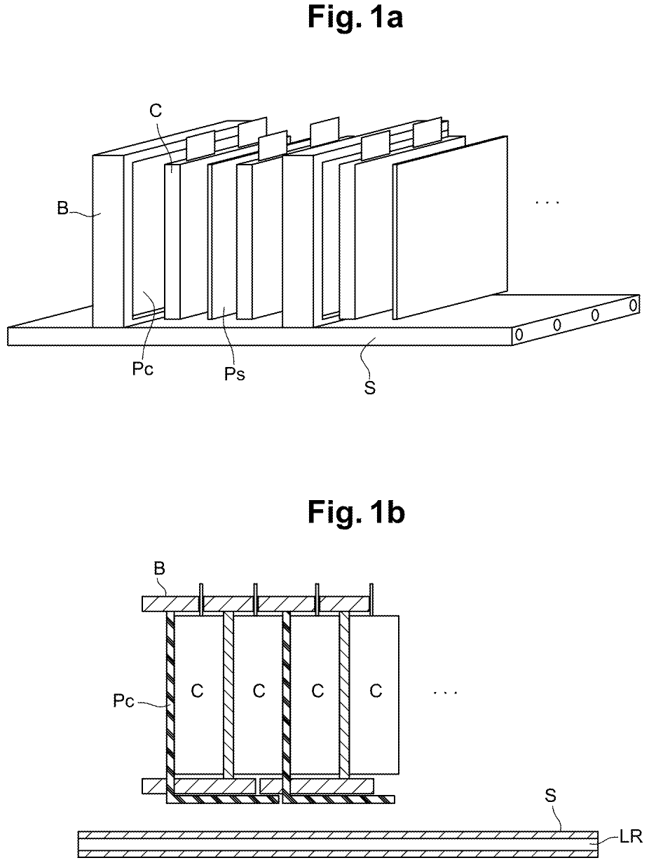

Example 1: A battery unit is used according to the configuration represented in FIGS. 1a and 1b. This battery unit has a rectangular parallelepiped shape, defined by a length of 277 mm, a width of 262 mm and a thickness of 254 mm. It comprises in particular 24 pouch-type cells C («pouch cells») grouped together in the form of 12 blocks of two cells separated by a foam plate PS formed from a silica gel, the cells C are disposed inside a plastic casing B. The casing B rests on a support S inside which a coolant LR circulates. The heat transfer takes place by means of aluminum and L-shaped conductive plates PC, each plate PC being disposed between two adjacent cell blocks. Each cell C has a rectangular parallelepiped shape, defined by a length of 227 mm, a width of 250 mm and a thickness of 10.5 mm. The heat given off by each cell C is 10 W. The respective thermal conductivities A of the various constituent elements of this battery unit are given in table 1 below:

TABLE 1

| | Constituent elements | | | | |
|---|---|---|---|---|---|
| | Cell | Coolant | Plate PS | Casing B | Plate PS |
| Thermal | 35 | 0.6203 | 2 | 0.25 | 237 |
| conductivity | | | | | |
| (in W/m · k) | | | | | |

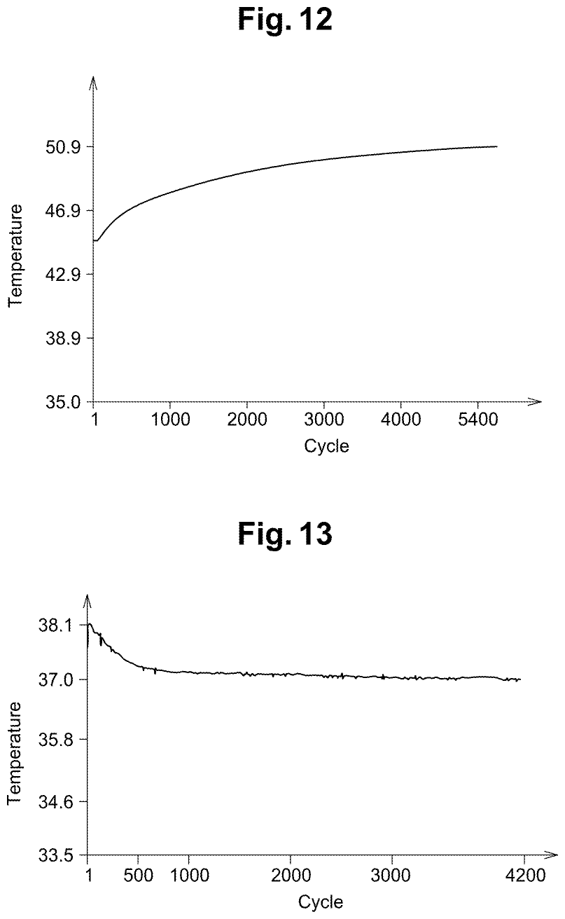

With reference to FIG. 12, there is represented a diagram representing the temperature variations (expressed in ° C.) of the cells C as a function of the cooling cycles (expressed in seconds). It is thus observed that the temperature gradually increases from an initial temperature of 45° C. to a final temperature of 50.9° C. This final temperature is too high and could potentially cause a risk of fire, or at least a significant degradation of the cells.

Example 2: A battery unit is used according to the configuration represented in FIGS. 2 to 4. This battery unit 1 has a rectangular parallelepiped shape, defined by a length of 316 mm, a width of 330 mm and a thickness of 132 mm. It comprises in particular 24 pouch-type cells 2 («pouch cells») grouped together in the form of 12 blocks 2′ of two cells separated by a foam plate 8 formed from a silica gel, the cells 2 are disposed inside a plastic casing 3 inside which a coolant LR circulates. The heat transfer takes place by means of plastic cooling plates 5 crossed by a plurality of inner channels 53, each plate 5 being disposed between two blocks 2′ of adjacent cells. Each cell 2 has a rectangular parallelepiped shape, defined by a length of 100 mm, a width of 302 mm and a thickness of 11.7 mm. The heat released by each cell 2 is 20 W. The thermal conductivities A, respective of the different constituent elements of this battery unit are given in table 2 below:

TABLE 2

| | Constituent elements | | | | |
|---|---|---|---|---|---|
| | Cell | Coolant | Plate 8 | Casing 3 | Plate 5 |
| Thermal | 35 | 0.6203 | 2 | 0.25 | 0.25 |
| conductivity | | | | | |
| (in W/m · k) | | | | | |

With reference to FIG. 13, there is represented a diagram representing the temperature variations (expressed in ° C.) of the cells C as a function of the cooling cycles (expressed in seconds). It is thus observed that the temperature slightly decreases from an initial temperature of 38.1° C. to a final temperature of 35.3° C.

This relatively low final temperature prevents cell degradation from occurring and ensures optimum operation of the battery unit.

Example 3: A battery unit is used depending on the configuration represented in FIGS. 5, 6 and 7a, 7b. This battery unit 1′ has the shape of a rectangular parallelepiped, defined by a length of 305 mm, a width of 330 mm and a thickness of 132 mm. It comprises in particular 24 pouch-type cells 2 («Pouch cells») grouped together in the form of 12 blocks 2′ of two cells separated by a foam plate 8 formed of a silica gel, the cells 2 are disposed inside a casing 3 made of a plastic material HCPC inside which a coolant LR circulates. The heat transfer takes place by means of cooling plates 5′ of plastic material HCPC and of substantially flat shape, each plate 5 being disposed between two blocks 2′ of adjacent cells. Each cell 2 has the shape of a rectangular parallelepiped, defined by a length of 100 mm, a width of 302 mm and a thickness of 11.7 mm. The heat released by each cell 2 is 20 W. The thermal conductivities A, respective of the different constituent elements of this battery unit are given in table 3 below:

TABLE 3

| | Constituent elements | | | | |
|---|---|---|---|---|---|
| | Cell | Coolant | Plate 8 | Casing 3 | Plate 5′ |
| Thermal | 35 | 0.6203 | 2 | 0.25 | 221 |
| conductivity | | | | | |
| (in W/m · k) | | | | | |

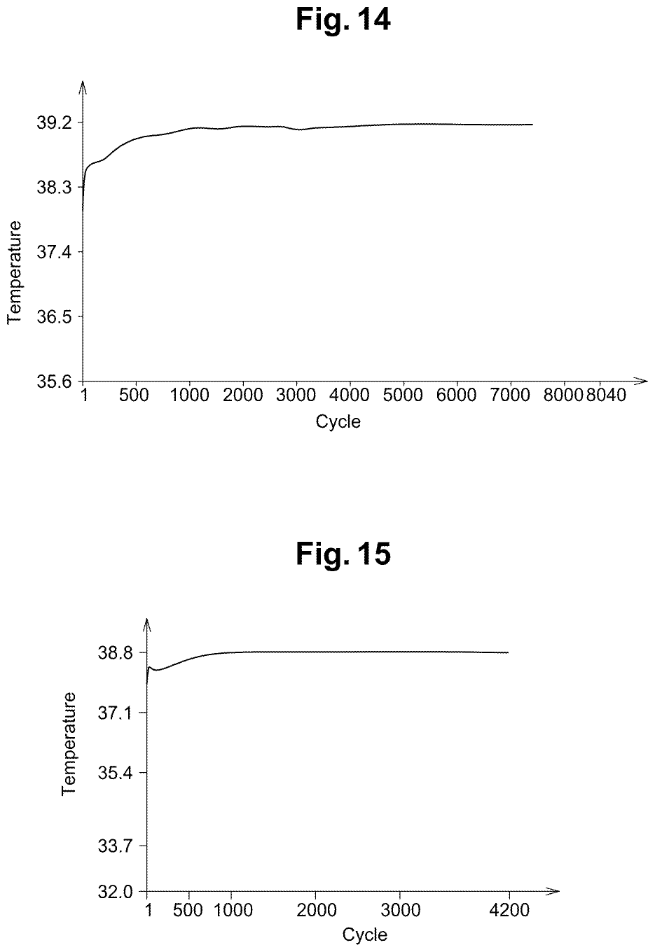

With reference to FIG. 14, there is represented a diagram representing the temperature variations (expressed in ° C.) of the cells C as a function of the cooling cycles (expressed in seconds). It is thus observed that the temperature slightly increases from an initial temperature of 38° C. to a final temperature of 39.2° C. This relatively low final temperature prevents cell degradation from occurring and ensures proper operation of the battery unit.

Example 4: A battery unit is used depending on the configuration represented in FIGS. 5 and 8. This battery unit 1′ has the shape of a rectangular parallelepiped, defined by a length of 299 mm, a width of 330 mm and a thickness of 132 mm. It comprises in particular 24 pouch-type cells 2 («pouch cells») grouped together in the form of 12 blocks 2′ of two cells separated by a foam plate 8 formed from a silica gel, the cells 2 are disposed inside a casing 3 made of a plastic material inside which a coolant LR circulates. The heat transfer takes place by means of L-shaped aluminum cooling plates 5′, each plate 5 being disposed between two blocks 2′ of adjacent cells. Each cell 2 has a shape of rectangular parallelepiped, defined by a length of 100 mm, a width of 302 mm and a thickness of 11.7 mm. The heat released by each cell 2 is 20 W. The thermal conductivities A, respective of the different constituent elements of this battery unit are given in table 4 below:

TABLE 4

| | Constituent elements | | | | |
|---|---|---|---|---|---|
| | Cell | Coolant | Plate 8 | Casing 3 | Plate 5′ |
| Thermal | 35 | 0.6203 | 2 | 0.25 | 237 |
| conductivity | | | | | |
| (in W/m · k) | | | | | |

With reference to FIG. 15, there is represented a diagram representing the temperature variations (expressed in ° C.) of the cells C as a function of the cooling cycles (expressed in seconds). It is thus observed that the temperature slightly increases from an initial temperature of 38° C. to a final temperature of 40.9° C. This relatively low final temperature prevents cell degradation from occurring and ensures proper operation of the battery unit.

1. A battery unit, in particular for an electric or hybrid motor vehicle, comprising:
a plurality of battery cells, optionally physically grouped together in modules of two or more battery cells, and
a casing housing and surrounding said plurality of battery cells, said casing comprising a lower wall, on which the battery cells rest, an upper wall, arranged above the battery cells, and lateral walls connecting the lower and upper walls,
wherein each of the lower and upper walls of the casing is traversed by at least one cooling channel, along which a coolant can flow, said cooling channel being configured to cover the entire surface of the lower wall, respectively of the upper wall, and in that the lower and upper walls of the casing are connected by a plurality of cooling plates, each cooling plate being disposed between two adjacent battery cells, or modules of adjacent battery cells, or being in contact with at least one battery cell, and being configured to transmit the heat generated by the battery cells to the coolant.

2. The battery unit according to claim 1, wherein each cooling plate is formed in a plastic material and includes a plurality of inner channels extending from an upper end opening into the cooling channel of the upper wall to a lower end opening into the cooling channel of the lower wall, configured to allowing a circulation of the coolant from the upper wall to the lower wall through said inner channels.

3. The battery unit according to claim 1, wherein the cooling plates are formed in a material having high thermal conductivity.

4. The battery unit according to claim 3, wherein the constituent material of the cooling plates has a thermal conductivity greater than or equal to 20 W·m⁻¹·K⁻¹.

5. The battery unit according to claim 3, wherein the cooling plates are formed in a thermally conductive plastic material.

6. The battery unit according to claim 3, wherein the cooling plates are formed in aluminum.

7. The battery unit according to claim 3, wherein the cooling plates are substantially flat.

8. The battery unit according to claim 7, wherein the cooling plates are overmolded with the casing.

9. The battery unit according to claim 3, wherein the cooling plates are U-shaped.

10. The battery unit according to claim 9, wherein the cooling plates are glued on the casing.

11. The battery unit according to claim 1, wherein the casing is provided with at least one inlet orifice and at least one outlet orifice, said at least one inlet orifice, respectively said at least one outlet orifice, communicating with the cooling channel so as to allow the inlet, respectively the outlet, of the coolant inside, respectively outside, the casing.

12. The battery unit according to claim 1, wherein the casing is formed by the assembly of several casing panels fixed together by connection means, said casing panels comprising at least two end panels disposed at each end of the casing and a plurality of intermediate panels interposed between said end panels.

13. The battery unit according to claim 12, wherein the connection means are screws cooperating with corresponding threads formed inside the casing panels.

14. The battery unit according to claim 12, wherein at least one of the end panels is equipped with an inlet and/or an outlet orifice, said inlet and/or outlet orifice communicating with the cooling channel so as to allow the inlet, respectively the outlet, of the coolant inside, respectively outside, the casing.

15. The battery unit according to claim 12, wherein each casing panel is secured to a single cooling plate.

16. A motor vehicle with comprising at least one battery unit according to claim 1.
